(19) United States
(12) Patent Application Publication
(10) Pub. No.: US 2014/0096044 A1
(43) Pub. Date: Apr. 3, 2014

(54) ELECTRONIC SYSTEM WITH CONTENT PRESENTATION MECHANISM AND METHOD OF OPERATION THEREOF

(71) Applicant: Samsung Electronics Co., Ltd., Gyeonggi-Do (KR)

(72) Inventors: Neil Everette, San Jose, CA (US); Wei-Meng Chee, Sunnyvale, CA (US); Kwame Ferreira, London (GB); Florian Dusch, Stuttgart (DE)

(73) Assignee: Samsung Electronics Co., Ltd., Gyeonggi-Do (KR)

(21) Appl. No.: 14/044,674

(22) Filed: Oct. 2, 2013

Related U.S. Application Data
(60) Provisional application No. 61/709,081, filed on Oct. 2, 2012.
(60) Provisional application No. 61/709,083, filed on Oct. 2, 2012.

(51) Int. Cl. G06F 3/0484

(52) U.S. Cl. CPC G06F 3/0484
USPC 715/764

(57) ABSTRACT

An electronic system includes: a control unit configured to select media based on a context factor for a media mix; and a display interface, coupled to the control unit, configured to display an adornment with the media mix on a device.

### CROSS-REFERENCE TO RELATED APPLICATION(S)

The present application contains subject matter related to a concurrently filed U.S. patent application by Guy Bar-Nahum et al. entitled “DISPLAY SYSTEM WITH CONTENT PRESENTATION MECHANISM AND METHOD OF OPERATION THEREOF”. The related application is assigned to Samsung Electronics Co., Ltd., application Ser. No. 14/044,578, filed Oct. 2, 2013. The subject matter thereof is incorporated herein by reference thereto. This application claims the benefit of U.S. Provisional Patent Application Ser. No. 61/709,081 filed Oct. 2, 2012, and U.S. Provisional Patent Application Ser. No. 61/709,083 filed Oct. 2, 2012, and the subject matter thereof is incorporated herein by reference thereto.

### TECHNICAL FIELD

An embodiment of the present invention relates generally to an electronic system, and more particularly to a system for content.

### BACKGROUND

Modern consumer and industrial electronics, especially devices such as graphical electronic systems, televisions, projectors, cellular phones, portable digital assistants, and combination devices, are providing increasing levels of functionality to support modern life including display and access to services. Research and development in the existing technologies can take a myriad of different directions.

In recent years content delivery or distribution over the Internet has become popular. Due to the advances in efficient file formats, the size of media files have become small enough to make their download via the Internet practical. Also, technological advances have led to higher-speed Internet connections and lower cost of memory. The combination of these advances make downloading media files, such as for images, documents, music, and videos, manageable and not too time consuming.

Electronic publishing and distribution embraces many different commercially available computer programs. Software has been developed that is specifically designed to electronically publish and distribute digital publications using the Internet. This software was designed to process documents in the format of conventional print publications.

Conventional systems for publishing or viewing digital publications have several problems, including those relating to standardization, formatting, and ease of use. Presently, there is no standard platform for publishers to electronically present their publications to subscribers. Some digital publications may be viewed using commonly available browsers, while other digital publications require the use of proprietary reader programs, which must be installed by subscribers on their devices in order for proprietary file extensions of those digital publications to be recognized or readable by those devices.

Multimedia content presentation on mobile devices includes simplistic interfaces derived from browser-based approaches to content display. Both flip-board type and flipping-book type applications only allow thumbing through unit content as a complete page. Attempting to duplicate the literal look and feel of a paper magazine, flip-board type and flipping-book type applications and their ilk, present static content.

Thus, a need still remains for an electronic system with content presentation. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system, including: a control unit configured to select media based on a context factor for a media mix; and a display interface, coupled to the control unit, configured to display an adornment with the media mix on a device.

An embodiment of the present invention provides a method of operation of an electronic system including: selecting, with a control unit, media based on a context factor for a media mix; and combining an adornment with the media mix configured to display on a device.

An embodiment of the present invention provides a non-transitory computer-readable medium with an executable program stored thereon including: selecting media based on a context factor for a media mix; and combining an adornment with the media mix configured to display on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system with image conversion mechanism in an embodiment of the present invention.

FIG. 2 is an example of a display interface of the first device.

FIG. 3 is an exemplary block diagram of the electronic system.

FIG. 4 is a control flow of the electronic system in an embodiment of the present invention.

FIG. 5 is an example of a display interface of the electronic system in an embodiment of the present invention.

FIG. 6 is an example of the display interface of the electronic system in an embodiment of the present invention.

FIG. 7 is an exemplary block diagram of as electronic system in an embodiment of the present invention.

FIG. 8 is a flow chart of a method of operation of an electronic system in an embodiment of the present invention.

### DETAILED DESCRIPTION

An embodiment of the present invention includes structure and content of the format of the display interface created dynamically based on a request or other user interaction. The user interaction can be contextual and incorporate requests such as a search with the content search module or an input device click, as well as social, spatial, and temporal context such as a user with a guest near a point of interest, so the user receives the format of the display interface with content about that point of interest or other similar points of interest within the user's proximity.

An embodiment of the present invention includes a system for creating playlists with personalized adornments are disclosed. Embodiments of the invention can relate to user customization of a playlist with personalized adornments that reflect the aesthetics of the user. A playlist can generally be referred to as a media mix. A media mix is a packaged collection of media content, such as video content, electronic books, games, apps, images, or a combination of different types of media content.

An embodiment of the present invention includes of a system for creating recommendation assisted media mixes are disclosed. Embodiments of the invention can relate to the distribution of music and music related multi-media content. Embodiments of the invention provide media mixes that allow for content customization 20 and shareability, while preserving the rights of content creators.

An embodiment of the present invention includes a magazine module or a magazine application providing customized magazine structure or content of a magazine format learned from a user's behavior such as a system for presenting dynamic multimedia content in a magazine style layout. Content can be related to multimedia presentation and user discovery on computing devices including multimedia presentation on mobile devices. The embodiment of the present invention addresses problems of simplistic interfaces derived from browser-based approaches for content display such as not formatted like magazines, do not have active content, or are not created dynamically in response to topic or context.

An embodiment of the present invention includes embodiments using at least a paper magazine as a model for content presentation and user discovery of content under general and variable subject areas. Presentation integrates elements of all of layout, structured elements, and content into a style reflecting paper magazines in terms of complexity, with dynamic (active) browsing and navigation through its content. A magazine can also be considered a metaphor for rich content-driven software applications.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

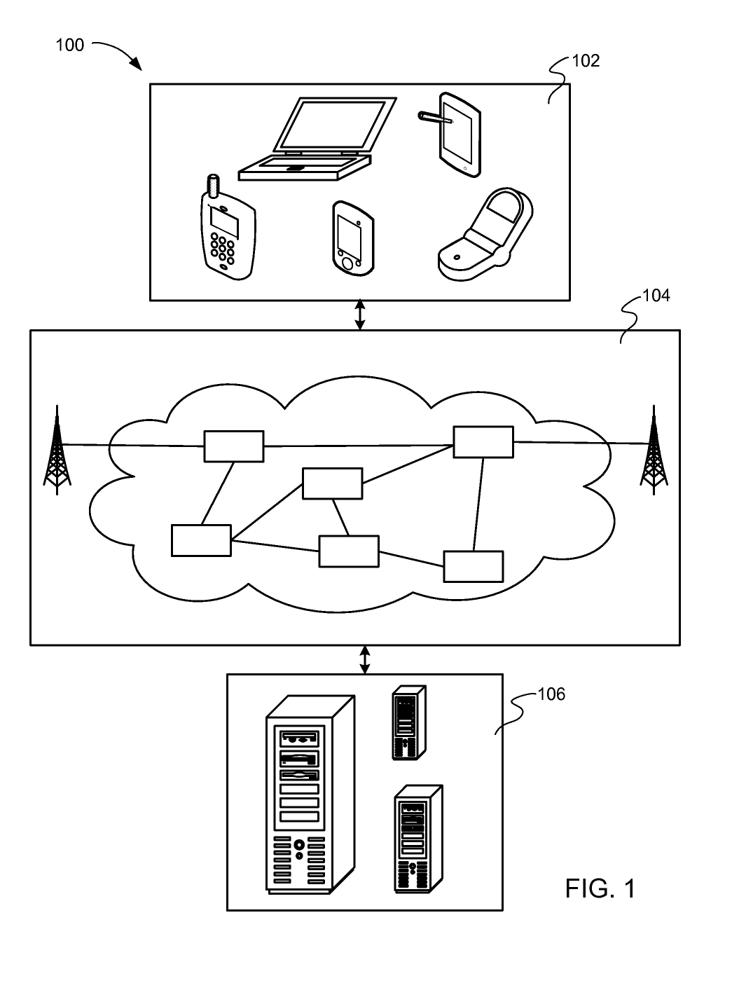

Referring now to FIG. 1, therein is shown an electronic system 100 with image conversion mechanism in an embodiment of the present invention. The electronic system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the electronic system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the electronic system 100 is described with the second device 106 as a computing device, although it is understood that the second device 106 can be different types of devices. Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (lrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

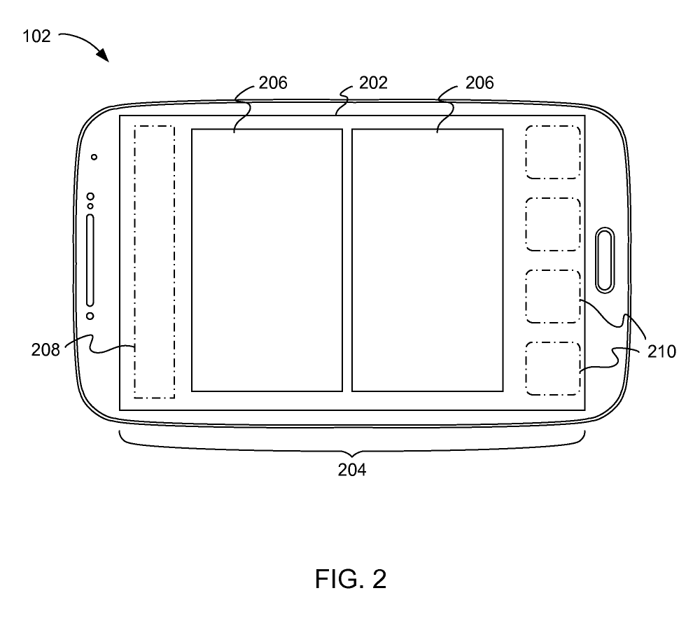

Referring now to FIG. 2, therein is shown an example of a display interface 202 of the first device 102 of FIG. 1. Similarly, the second device 106 of FIG. 1 can also include a display interface such as the display interface 202. The display interface 202 can display a format 204 such as a magazine format including an image 206, a text 208, a symbol 210, or combination thereof. The format 204 can include the text 208, associated with the image 206, overlapped or wrapped with the text 208.

The image 206, the text 208, or the symbol 210 can represent content specific to preferences, selections, viewing time, or combination thereof. The image 206 can include photos, drawings, or combination thereof. The text 208 can include words or phrases, in columns, paragraphs, headings, or footers. The symbol 210 can include non-ASCII characters, icons, or combination thereof.

Objects including the image 206 the text 208, or the symbol 210 can optionally be radio buttons, selectable, clickable, static, or combination thereof. The content represented by the objects, specific to preferences, selections, viewing time, or combination thereof, can preferably include links to other pages in the same other documents, web sites, web pages, pages in the same document, context, application, or ecosystem.

Selecting, clicking, or activating, the objects preferably provides navigation or access to related content in a format consistent with the format 204. The symbol 210 can also be consistent with the related content and the format 204 and can change dynamically such as dynamic symbols 210 based on the related content, selection, activation, or combination thereof. For example, different size, shape, color, configuration, or combination thereof, can distinguish the symbol 210 for playing content, the symbol 210 for getting more information, the symbols for buying a service, or the symbols for buying a product.

For example, the format 204 such as a magazine including the text 208 associated with the image 206 can link or seed generation of another of the format 204 such as another magazine. Further for example, a topic or subject related to content of the format 204, such as “MUSIC”, can include the image 206 adorned with user-defined augmented content such as stickers, handwriting, or combination thereof, related to the content of the format 204.

A page of the format 204 can also identify content subsections within the content of the format 204 such as a cover story subsection, a featured album subsection, any other content, or combination thereof. The cover page may further include embedded or integrated controls for playing content such as playing a song from an album featured in the featured album subsection of the content of the format 204.

For illustrative purposes, the format 204 is shown with the objects that can selected, clicked, or activated for navigation or access to related content although it is understood that hands free activation or navigation such as contextually relevant speech controls may also be used. Similarly, a user of the content of the format 204 may designate content to be read aloud in a predefined language.

It has been discovered that the electronic system 100 with the format 204 utilizing the images 206 the text 208, or the symbols 210 can provide a user with a consistent interface including links to other pages in the same other documents, web sites, web pages, pages in the same document, context, application, or ecosystem. The user can easily navigate and view related content in the same document, context, application, or ecosystem without interruption or distraction.

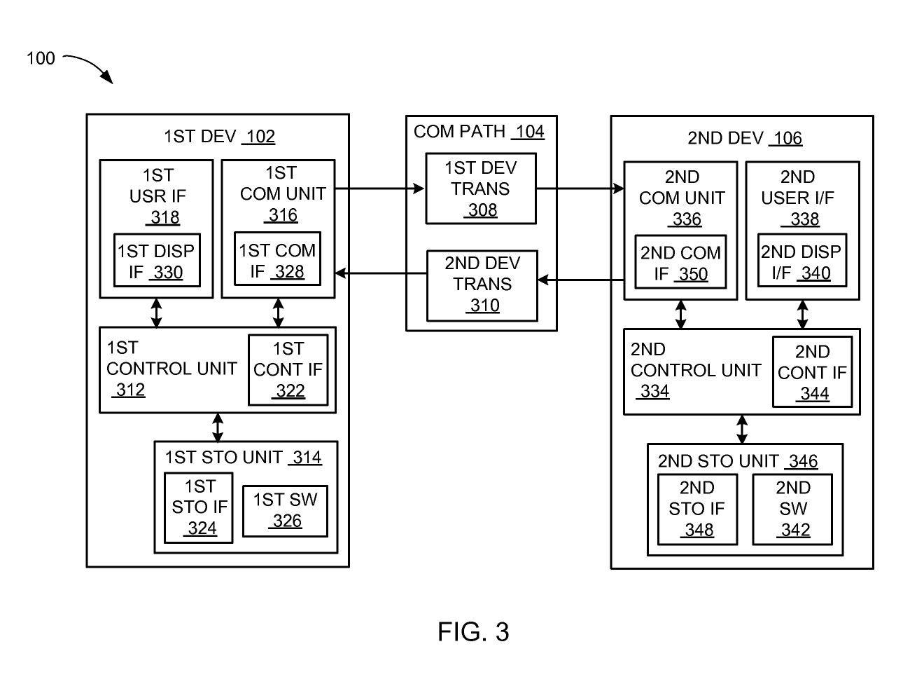

Referring now to FIG. 3, therein is shown an exemplary block diagram of the electronic system 100. The electronic system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server having a display interface.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318. The first control unit 312 can include a first control interface 322. The first control unit 312 can execute a first software 326 to provide the intelligence of the electronic system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, an infrared sensor for receiving remote signals, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the electronic system 100. The first control unit 312 can also execute the first software 326 for the other functions of the electronic system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the electronic system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the electronic system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the electronic system 100 is shown with the second storage unit 346 as a single hierarchy storage system, although it is understood that the electronic system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The electronic system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100.

The modules described in this application can be implemented as instructions stored on a non-transitory computer readable medium to be executed by a first control unit 312 of FIG. 3, the second control unit 334 of FIG. 3, or a combination thereof. The non-transitory computer-readable medium can include the first storage unit 314 of FIG. 3, the second storage unit 346 of FIG. 3, or a combination thereof. The non-transitory computer-readable medium can include non-volatile memory, such as a hard disk drive (HDD), non-volatile random access memory (NVRAM), solid-state storage device (SSD), compact disk (CD), digital video disk (DVD), universal serial bus (USB) flash memory devices, Blu-ray Disc™, any other computer readable media, or combination thereof. The non-transitory computer readable medium can be integrated as a part of the electronic system 100 or installed as a removable portion of the electronic system 100.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the electronic system 100.

The electronic system 100 has been described with module functions or order as an example. The electronic system 100 can partition the modules differently or order the modules differently. The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

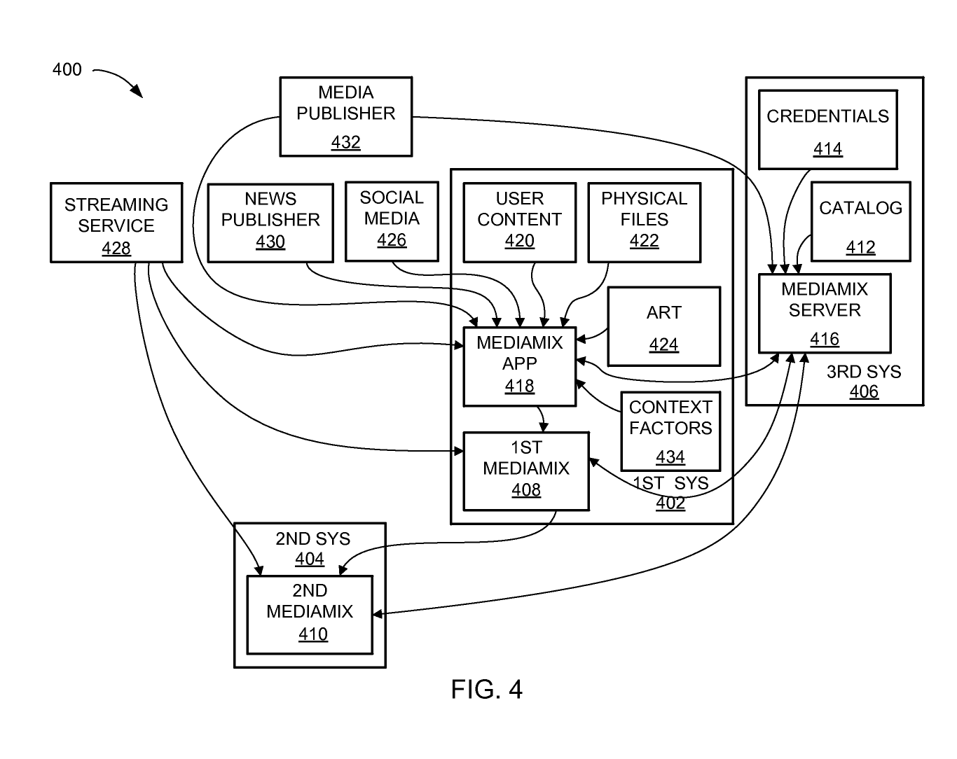

Referring now to FIG. 4, therein is shown a control flow of the electronic system 400 in an embodiment of the present invention. The electronic system 400 can include a first subsystem 402, a second subsystem 404, and a third subsystem 406. The first subsystem 402, the second subsystem 404, and the third subsystem 406 can be implemented as the first device 102 of FIG. 1 or the second device 106 of FIG. 1.

For example, the third subsystem 406 can be implemented as a server for providing a first media mix 408 to the first subsystem 402, which can be implemented as a first user device, or a second media mix 410 to the second subsystem 404, which can be implemented as a second user device. The first media mix 408 can be substantially the same as or different from the second media mix 410.

The first media mix 408 or the second media mix 410 can be a playlist containing a packaged collection of media content, such as video content, electronic books, games, applications, images, audio, or combination thereof. Just as a music collection can be packaged to reflect the aesthetics of an individual, the “mix tape” analogy can be extended to packaged collections of video content, electronic books, games, apps, images, and combinations of media types. Media and content can be obtained from multiple computing devices including television, phone, smart appliance, cloud-based services, or combination thereof.

The first media mix 408 or the second media mix 410 can include media or content from a catalog 412 such as a database catalog, which can include or maintain the media content. The first media mix 408 or the second media mix 410 can also include content from a credentials database 414, which can include or maintain authentication or identification for users. The first media mix 408 or the second media mix 410 are not directly tied to services streaming the listed music, or producer of DRM-restricted content, but can transport license information. Thus the first media mix 408 or the second media mix 410 can be portable and shared with other users or devices such as the first device 102 or the second device 106. All users who receive the first media mix 408 or the second media mix 410 can be tracked.

The third subsystem 406 can include a server 416 such as a media mix server 416 for communicating with multiple user devices, such as the first subsystem 402 and the second subsystem 404, through the communication path 104 of FIG. 1. The third subsystem 406 with the media mix server 416 can receive licensing information, rules, digital rights management (DRM), or combination thereof for media content of one or more content providers including music publishers. The first media mix 408 or the second media mix 410 can have configurable duration DRM permissions to allow “try and buy” for recipients.

The first subsystem 402 and the second subsystem 404 implemented as user devices can include an application 418 such as a media mix application 418. The media mix application 418 can communicate with the media mix server 416 or another of the media mix application 418 on another of the user device. The first subsystem 402, the second subsystem 404, the third subsystem 406, or combination thereof can be part of a “hub” for music owners. The “hub” can be a private network of users for interaction, sharing, or combination thereof, for information and media including music.

The first subsystem 402 can also include a user content database 420, physical files 422 such as a music collection database 422, an art database 424, other media content, or combination thereof. The media mix application 418 can also include a media mix creator module for communicating with the media mix server 416, social media 426, streaming media services 428, a news publisher 430, a media publisher 432, or combination thereof. The media mix application 418 can sort, select, track, evaluate, format, compare, combine, or combination thereof, media mix content based on context factors 434.

It has been discovered that the electronic system 400 with the media mix application 418 including the media mix creator module can provide a magazine like experience, dynamically changing content, social value including sharing with a user group such as a user's circle, viral sharing across social media sites such as Facebook©, or combination thereof.

Further it has been discovered that the electronic system 400 with the media mix application 418 can integrate or mix media from multiple sources including media from the art database 424 to provide the media mix 408 or 410 to the first subsystem 402 or the second subsystem 404 implemented as user devices.

The electronic system 400 has been described with module functions or order as an example. The electronic system 400 can partition the modules differently or order the modules differently. For example, the media publisher 432 can directly provide content to the user content database 420, the physical files 422, the social media 426, the streaming media services 428 or combination thereof.

The modules described in this application can be hardware implementation or hardware accelerators in the first control unit 316 of FIG. 3 or in the second control unit 338 of FIG. 3. The modules can also be hardware implementation or hardware accelerators within the first device 102 or the second device 106 but outside of the first control unit 316 or the second control unit 338, respectively.

The media mix application 418 can be implemented as: hardware in the first control unit 312 or the second control unit 334: software stored in the first storage unit 314 or the second storage unit 346 and executed by the first control unit 312 or the second control unit 334; or combination thereof, programmed for displaying, sorting, selecting, tracking, evaluating, formatting, comparing, combining, distributing, and playback.

The first media mix 408, the second media mix 410, and the media mix 508 can implemented as software stored in the first storage unit 314 or the second storage unit 346 and, executed by the first control unit 312 or the second control unit 334 particularly programmed for displaying, tracking, evaluating, comparing, distributing, and playback.

The physical files 422, the user content database 420, the credentials database 414, and the catalog 412 can implemented as software stored in the first storage unit 314 or the second storage unit 346 and, executed by the first control unit 312 or the second control unit 334 particularly programmed for sorting, evaluating, displaying, formatting, combining, and distributing.

The physical transformation from the content provided to the media mix application 418 results in the movement in the physical world, such as audio and display output from the first subsystem 402 or the second subsystem 404. Movement in the physical world results in changes to the display interface 202 of FIG. 2, the first display interface 330 of FIG. 3, the second display interface 350 of FIG. 3, audio interface, or combination thereof by output from the media mix application 418.

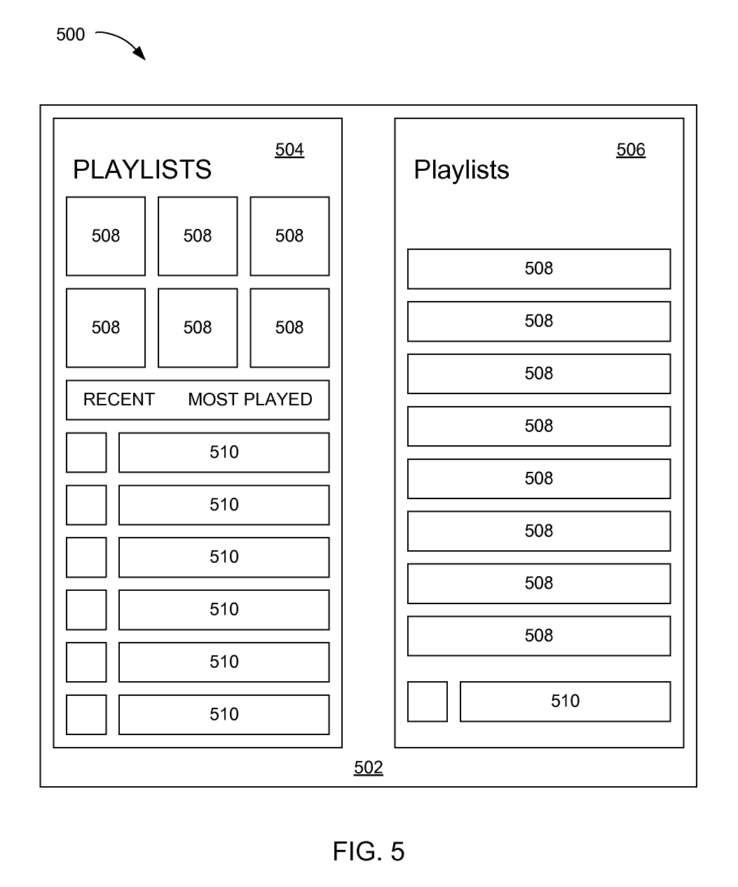

Referring now to FIG. 5, therein is shown an example of a display interface 502 of the electronic system 500 in an embodiment of the present invention. The display interface 502 can include a first media mix format 504 and a second media mix format 506.

The media mix application 418 of FIG. 4 can be software or hardware that displays the first media mix format 504 or the second media mix format 506 for the first media mix 408 of FIG. 4 or the second media mix 410 of FIG. 4, media mixes 508, or combination thereof. The media mix application 418 can automatically create or recommended the media mixes 508 such as an automatic playlists, a relevant playlists, or combination thereof.

Media entries 510 can be selected for any of the media mixes 508 based on the context factors 434 of FIG. 4 such as social factors including from the social media 426 of FIG. 4, usage history including from user content 420 of FIG. 4, location including proximity to points of interest and services, organization affiliation, celebrity preference, or combination thereof. The media entries 510 can be automatically selected or recommended if relevant based on a combination of the above factors.

Social factors can include demographics, communication frequency, location, or combination thereof. Demographic analysis can include usage of the media mix application 418 based on user device or server access, analogous services, analogous groups of users, or combination thereof. Communication frequency can include number of peer to peer communications, timing of peer to peer communications, audio or spoken communication, textual communication including social media posts, short message service (SMS), email, other communication, or combination thereof.

Spatial location including device proximity can be inherited or combined with other factors based on a global positioning system (GPS), wireless fidelity (Wi-Fi) provider, location of devices in peer-to-peer communication, any location information, or combination thereof. Organization or celebrity attributes can also be inherited or combined with other factor.

The media entries 510 can also be selected for any of the media mixes 508 based on themes, preferences, usage consumption patterns, evolution in selections, frequency of selections, quantity of other users selections, event type, environment, intended user, order of content, or combination thereof. These factors can be combined with any other factors such as demographics, communication frequency, location, organization attributes, celebrity attributes, or combination thereof.

A user's or users' theme, preference, or taste can be determined by tracking patterns of consumption or usage. A user's or users' taste or preferences can also change providing a pattern or evolution that can provide predictions for the media entries 510 of the media mixes 508. The patterns of consumption or usage can include how often a media entry 510 is accessed such as played, rewound, or combination thereof. The other users' selections can include how many users, such as in a group “circle”, play, purchase, request, or combination thereof, the media entry 510.

Context can also include whether the event type is live or recorded, whether the environment is personal, professional, driving, or a group, whether the media entries 510 are for another user, or whether the media entries 510 have an ordinal relationship such as a series of books, programs, games, presentations, sequential media, or combination thereof.

The media entries 510 for any of the media mixes 508 can be assigned a rank for selection or recommendation. The rank can be based on discovery of patterns or preferences based on the aforementioned factors, attributes, context, or combination thereof. The rank can also provide engagement of a user or users also based on the aforementioned factors, attributes, context, or combination thereof.

For example, the electronic system 500 can play instrumental music only without lyrics when in the workplace to avoid distraction. Further, the electronic system 500 can play recommendations via social media from a gym trainer to play while physically exercising.

It has been discovered that the first media mix 408 and the second media mix 410 can be shared with others as a unified object. The first media mix 408 and the second media mix 410 are not directly tied to whichever service streams the listed music, or whichever producer of DRM-restricted content, but are still able to transport license information, in contrast to saved searches, playlists, and blogs.

Further it has been discovered that selection of the media entries 510 for the media mixes 508 including the first media mix 408 and the second media mix 410, based on the actors, attributes, and context can provide discovery, predictions, engagement, or combination thereof, for the user.

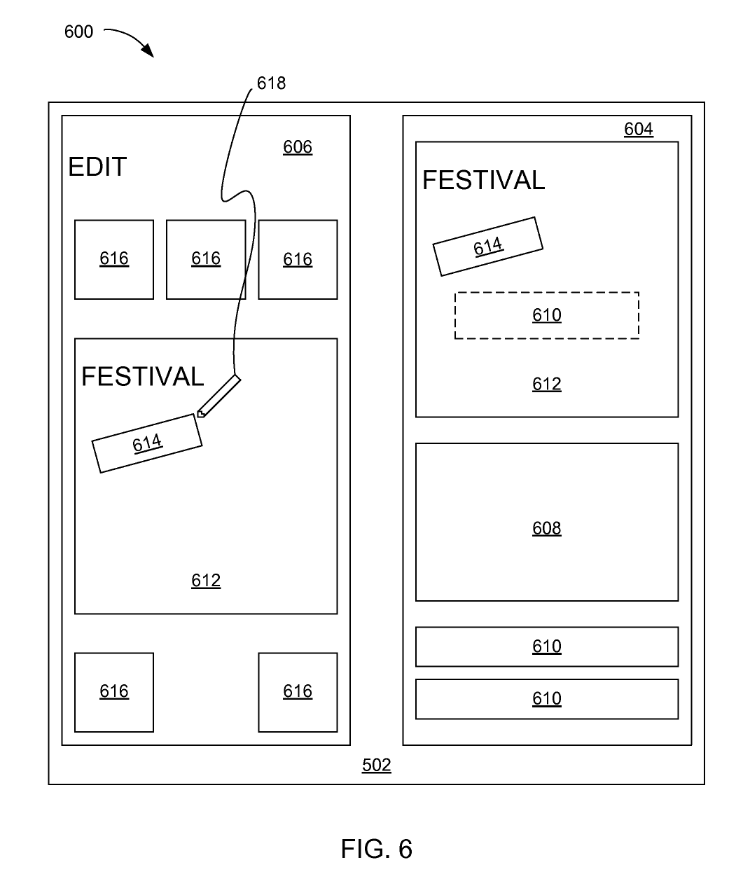

Referring now to FIG. 6, therein is shown an example of the display interface 502 of the electronic system 500 in an embodiment of the present invention. The display interface 502 can include a media mix format 604.

The media mix application 418 of FIG. 4 can be software or hardware that displays the media mix format 604. The media mix application 418 can automatically create or recommended the media mixes 508 of FIG. 5 such as an automatic playlists, a relevant playlists, or combination thereof. Media entries 610 can be selected for the media mixes 508 based on the context factors 434 of FIG. 4. The media entries 510 can be automatically selected or recommended if relevant based on a combination of the above factors.

The media mix format 604 can include visual media 608 such as graphics, multimedia, links, or combination thereof. The media mix 508 can also be represented in the visual media 608 and the media entries 610. The visual media 608 can include a user image, an artist image, a video, graphics media, or combination thereof.

The media mix 508 such as a playlist can be represented by a media mix graphic 612. The media mix graphic 612 can include or be adorned with an adornment 614 of user-defined augmented content including personalized stickers, handwriting on the magazine, drawing, graffiti, sketch, other types of user-defined augmented content, or combination thereof. The adornments combined with the media mix 508 can have a suggested location and users will have the ability to change the layout and look. Adornments 614 can be of any media type: sound, video, text, image, or combination thereof.

The media mix 508 can be protected such that when shared, other users cannot change the media mix 508 without altering an identifier 610 such as watermark. The identifier 610 can be uniquely created by a user providing or creating the media mix 508. Preferably, alterations cannot be shared.

The adornments 614 and the identifier 610 combined with the media mix 508 can provide user customization and personalization for the media mix 508 such as a personalized and packaged music playlist for sharing with peers. The customization with the adornments 614 and the identifier 610 can provide a high degree of customization and significantly distinguish a tightly-defined framework for the media mix 508 representing a playlist.

The media mix 508 with the media mix graphic 612 can include, be combined with, or be adorned with the adornments 614 and the identifier 610 based on context, mix of content, users, intended users, other factors, attributes, context, or combination thereof. The first media mix 408 of FIG. 4, the second media mix 410, the media mix 508, or combination thereof can include the adornments 614 and the identifier 610 for sharing as a unified object with other users.

The display interface 502 can also include an editing format 606. The editing format 606 can include editing menu items 616 such as stickers, images, drawing, remove, save, other editing commands, or combination thereof. For example, the editing menu item 616 can provide a drawing menu including a drawing tool 618 to modify the adornment 614, augment the adornment 614, add another of the adornment 614, or combination thereof.

It has been discovered that the electronic system 500 with the adornments 614 or the identifier 610 can provide a high degree of user personalization or customization beyond words and playlists within a tightly-defined framework. The user personalization or customization of the media mix 508 differs significantly with saved searches, playlists, and blogs.

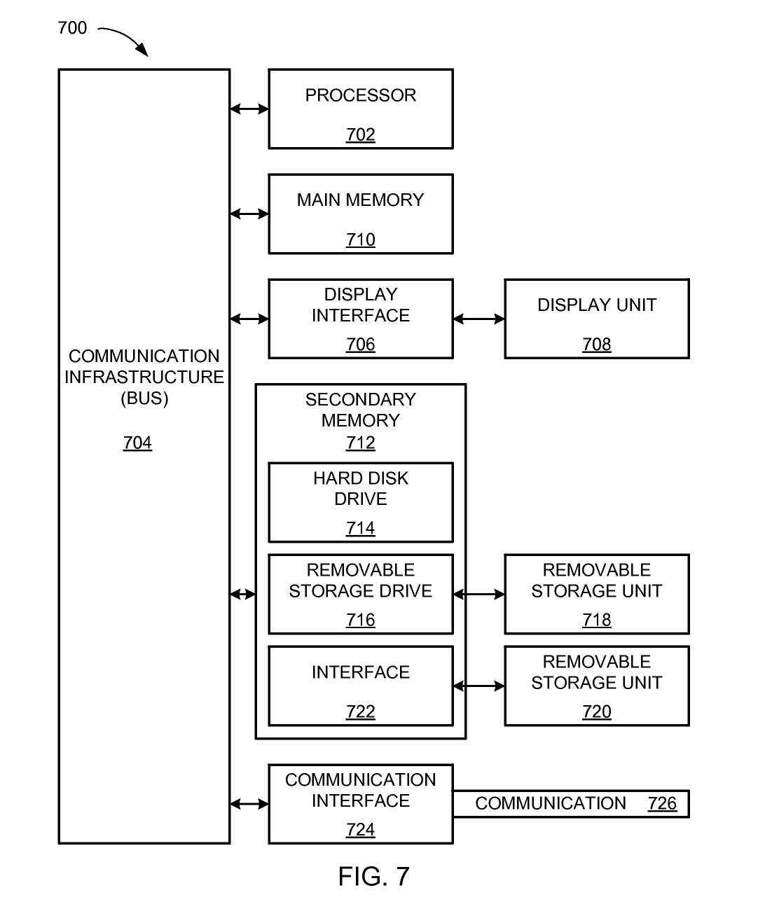

Referring now to FIG. 7, therein is shown an exemplary block diagram of an electronic system 700 in an embodiment of the present invention. The electronic system 700 can provide information processing system useful for implementing one embodiment of the present invention. A computer system such as the first device 102 of FIG. 1 or the second device of FIG. 1 can include one or more processors, such as processor 702. The processor 702 can be connected to a communication infrastructure 704 such as a communications bus, cross-over bar, or network.

The computer system can include a display interface 706 that forwards graphics, text, and other data from the communication infrastructure 704 or from a frame buffer (not shown) for display on a display unit 708. The computer system also includes a main memory 710, preferably random access memory (RAM), and may also include a secondary memory 712. The secondary memory 712 may include, for example, a hard disk drive 714, a removable storage drive 716, or combination thereof, representing for example a floppy disk drive, a magnetic tape drive, or an optical disk drive.

The removable storage drive 716 communicates with, such as reads from, writes to, or combination thereof, a removable storage unit 718. The removable storage unit 718 represents, for example, a floppy disk, a compact disc, a magnetic tape, an optical disk, other storage devices, or combination thereof, which is read by and written to the removable storage drive 716. As will be appreciated, the removable storage unit 718 includes a computer readable medium having stored therein computer software, data, or combination thereof.

In alternative embodiments, the secondary memory 712 may include other similar means for allowing computer programs or other instructions to be loaded into the computer system. Such means may include, for example, a removable storage unit 720 and an interface 722. Examples of such means may include a program package and package interface (such as that found in video game devices), a removable memory chip (such as an EPROM, or PROM) and associated socket, and other removable storage units 720 and interfaces 722 which allow software and data to be transferred from the removable storage unit 720 to the computer system.

The computer system may also include a communication interface 724. Communication interface 724 allows software and data to be transferred between the computer system and external devices. Examples of communication interface 724 may include a modem, a network interface (such as an Ethernet card), a communication port, or a PCMCIA slot and card, etc. Software and data transferred via communication interface 724 are in the form of signals which may be, for example, electronic, electromagnetic, optical, or other signals capable of being received by communication interface 724. These signals are provided to communication interface 724 via a communication path 726 or channel. This communication path 726 carries signals and may be implemented using wire or cable, fiber optics, a phone line, a cellular phone link, an RF link, and/or other communication channels.

In this document, the terms “computer program medium,” “computer usable medium,” and “computer readable medium” are used to generally refer to media such as main memory 710 and secondary memory 712, removable storage drive 716, and a hard disk installed in hard disk drive 714.

Computer programs also called computer control logic are stored in main memory 710 and/or secondary memory 712. Computer programs may also be received via communication interface 724. Such computer programs, when run, enable the computer system to perform the features of an embodiment of the present invention as discussed herein. In particular, the computer programs, when run, enable the processor 702 to perform the features of the computer system. Accordingly, such computer programs represent controllers of the computer system.

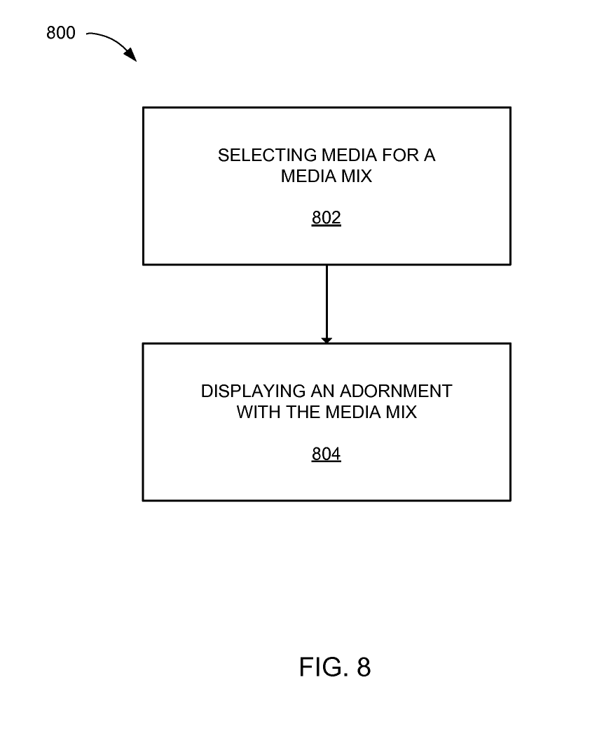

Referring now to FIG. 8, therein is shown a flow chart of a method 800 of operation of an electronic system 100 in an embodiment of the present invention. The method 800 includes: selecting, with a control unit, media based on a context factor for a media mix in a block 802; and combining an adornment with the media mix configured to display on a device in a block 804.

An embodiment of the present invention includes the electronic system 100 with the format 204 utilizing the images 206 the text 208, or the symbols 210 providing a user with a consistent interface including links to other pages in the same other documents, web sites, web pages, pages in the same document, context, application, or ecosystem. The user can easily navigate and view related content in the same document, context, application, or ecosystem without interruption or distraction.

Another embodiment of the present invention includes the electronic system 400 with the media mix application 418 including the media mix creator module providing a magazine like experience, dynamically changing content, social value including sharing with a user group such as a user's circle, viral sharing across social media sites such as Facebook©, or combination thereof.

Yet another embodiment of the present invention includes the electronic system 400 with the media mix application 418 integrating or mixing media from multiple sources including media from the art database 424 to provide the media mix 408 or 410 to the first subsystem 402 or the second subsystem 404 implemented as user devices.

Yet another embodiment of the present invention includes the first media mix 408 and the second media mix 410 shared with others as a unified object. The first media mix 408 and the second media mix 410 are not directly tied to whichever service streams the listed music, or whichever producer of DRM-restricted content, but are still able to transport license information, in contrast to saved searches, playlists, and blogs.

Yet another embodiment of the present invention includes selection of the media entries 510 for the media mixes 508 including the first media mix 408 and the second media mix 410, based on the actors, attributes, and context can provide discovery, predictions, engagement, or combination thereof, for the user.

Yet another embodiment of the present invention includes the electronic system 500 with the adornments 614 or the identifier 610 providing a high degree of user personalization or customization beyond words and playlists within a tightly-defined framework. The user personalization or customization of the media mix 508 differs significantly with saved searches, playlists, and blogs.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a control unit configured to select media based on a context factor for a media mix; and
a display interface, coupled to the control unit, configured to display an adornment with the media mix on a device.

2. The system as claimed in claim 1 further comprising a communication unit, coupled to the control unit, configured to share the media mix.

3. The system as claimed in claim 1 wherein the display interface configured to display user-defined augmented content.

4. The system as claimed in claim 1 wherein the display interface configured to display the adornment based on context.

5. The system as claimed in claim 1 wherein the control unit configured to select the media based on a social factor.

6. The system as claimed in claim 1 wherein the control unit configured to select the media based on a prediction.

7. The system as claimed in claim 1 further comprising a storage unit, coupled to the control unit, configured to store a media mix application creating the media mix.

8. A method of operation of an electronic system comprising:
selecting, with a control unit, media based on a context factor for a media mix; and
combining an adornment with the media mix configured to display on a device.

9. The method as claimed in claim 8 further comprising sharing the media mix.

10. The method as claimed in claim 8 wherein displaying the adornment includes displaying user-defined augmented content.

11. The method as claimed in claim 8 wherein displaying the adornment includes displaying the adornment based on context.

12. The method as claimed in claim 8 wherein selecting the media based on the context factor for the media mix includes selecting the media based on a social factor.

13. The method as claimed in claim 8 wherein selecting the media based on the context factor for the media mix includes selecting the media based on a prediction.

14. The method as claimed in claim 8 further comprising storing a media mix application configured to create the media mix.

15. A non-transitory computer-readable medium with an executable program stored thereon comprising:
selecting media based on a context factor for a media mix; and
combining an adornment with the media mix configured to display on a device.

16. The medium as claimed in claim 15 further comprising sharing the media mix.

17. The medium as claimed in claim 15 wherein displaying the adornment includes displaying user-defined augmented content.

18. The medium as claimed in claim 15 wherein displaying the adornment includes displaying the adornment based on context.

19. The medium as claimed in claim 15 wherein selecting the media based on the context factor for the media mix includes selecting the media based on a social factor.

20. The medium as claimed in claim 15 wherein selecting the media based on the context factor for the media mix includes selecting the media based on a prediction.
